(19) United States
(12) Patent Application Publication
(10) Pub. No.: US 2019/0060854 A1
(43) Pub. Date: Feb. 28, 2019

(54) STRUCTURED ELEMENT COATED IN A DISTINGUISHED MANNER AND SERVING AS SUPPORT FOR THE FLOW OF SEVERAL FLUIDS

(71) Applicant: COMMISSARIAT À L'ÉNERGIE ATOMIQUE ET AUX ÉNERGIES ALTERNATIVES, Paris (FR)

(72) Inventors: Olivier Dellea, La Talaudiere (FR); Pascal Fugier, Bernin (FR)

(21) Appl. No.: 16/108,541

(22) Filed: Aug. 22, 2018

(30) Foreign Application Priority Data
Aug. 23, 2017 (FR) 17 57836

(51) Int. Cl. B01F 13/00; B01F 13/02; B01F 5/06; B29C 59/02

(52) U.S. Cl. CPC B01F 13/0059; B01F 13/0222; B29C 2059/023; B29C 59/022; B01F 5/0611

(57) ABSTRACT

A structured element intended to be in contact with at least one first fluid and one second fluid, the structured element comprising a surface for circulating fluids structured by the presence of air cavities with a depth of between 100 and 1000 μm and distributed regularly over the structured surface, each cavity being delimited by a cavity surface. According to the invention, the cavity surface comprises at least one first zone and one second zone succeeding one another along a direction of depth of the cavity, the first zone being coated with a first set of particles having properties for repelling the first fluid, and the second zone being coated with a second set of particles, different from the first set.

### TECHNICAL FIELD

The invention relates to the field of fluid flow on an element, and more specifically on an element structured by the presence of air cavities distributed regularly over the structured surface of this element.

The invention is applied to all technical fields wherein it is sought to favour the flow of several fluids, circulating successively or simultaneously over a given element.

As a non-limiting example, the invention is applied to static mixers, of which the mixing elements must enable a satisfactory flow of the present fluids, while ensuring the mixture thereof.

### PRIOR ART

In the field of fluid flow, it is known to implement structured elements by the presence of low-depth cavities. These cavities are small air cells, with a closed bottom, usually used so as to be flared in the direction going from the bottom to the opening. During the flow of the fluid(s) over this type of structured element, the air is trapped in the cavities and enables to form a support for this/these fluid(s), with reduced friction. This principle is, for example, known for the flow of water, with the implementation of surfaces referred to as hydrophobic or superhydrophobic, provided with small cavities wherein the air is pressurised on contact with water.

However, according to the type of the present fluids, these are likely to be deposited in the bottom of all or some of the cavities provided over the structured element. This reduces the flow performance, because of the increase of friction.

### DESCRIPTION OF THE INVENTION

To resolve, at least partially, the problem identified above, the invention first aims for a structured element intended to be in contact with at least one first fluid and one second fluid, the structured element comprising a surface for circulation of fluids, structured by the presence of air cavities with a depth of between 100 and 1000 μm and distributed regularly over the structured surface, each cavity being delimited by a cavity surface.

According to the invention, the cavity surface comprises at least one first zone and one second zone succeeding one another along a direction of depth of the cavity, the first zone being coated with a first set of particles having properties for repelling the first fluid, and the second zone being coated with a second set of particles, different from the first set, and having properties for repelling the second fluid, the second set of particles ensuring a weaker repulsion of the first fluid than the first set of particles, whereas this latter ensures a weaker repulsion of the second fluid than the second set of particles.

The invention, because of this, gives a clever response to the risk of filling the cavities with present fluids, by producing a distinguished repellent coating of particles within this cavity. This, the risks that one of the fluids is deposited in the bottom of the cavities are reduced, that these fluids circulate simultaneously or successively over the structured surface of the element. By limiting these risks, the fluid flow can best benefit the advantages given by the cavities aiming to favour slippage, and to reduce friction.

For information purposes, in the specific case of one of the considered applications relating to static mixers, the functional maintenance of the cavities offers an additional advantage to that of improving the flow. Indeed, over the structured circulation surface, the zone rotation with and without slippage leads to direct consequences regarding hydrodynamic dispersion. In other words, the variation in the speed distribution created by the rotation of slipping zones at the level of the air-filled cavities, and of less-slipping zones at the level of the smooth parts of this surface, constitutes a source for recirculation of fluids. This trend generates turbulence and consequently proves to be conducive to a better mixture of the fluids within the static mixer, of which the overall performance is increased.

The invention preferably provided at least one of the following optional characteristics, taken by itself or in combination.

The depth of the air cavities is still more preferably between 100 and 500 μm.

Said first and second sets of particles comprise particles of which the greatest size is between 0.2 and 10 μm.

Said first and second sets of particles comprise flat and/or hemispheric shaped particles, even if any other shape can be considered, without moving away from the scope of the invention.

The cavities are distributed regularly over the structured surface along a triangular, square, rectangular or hexagonal-shaped mesh.

Each cavity has a greater size of between 600 and 750 μm.

Each cavity is flared by moving closer to the opening thereof, and preferably takes the general shape of a cone or of a pyramid, possibly truncated. In this scenario, each cavity can have a lower, cylindrical-shaped part forming a reservoir, of which the bottom is preferably coated with particles.

Each first/second set of particles extends along a closed line of the first/second zone of the cavity surface.

Alternatively to the mesh solution, cavities can be distributed regularly over the structured surface by forming parallel grooves.

Said cavity surface has a tilt, with respect to a direction of depth of the cavity, between 15 and 35°, and more specifically between 20 and 30°.

Preferably, the element is produced using one of the following materials:
high-density polyethylene;
polymethylmethacrylate;
polycarbonate.

Other materials can however be considered, in particular in the family of amorphous and semi-crystalline thermoplastic polymers. Thus, other materials possible for the production of the structured element are, for example: ABS, polyphenylsulfone, polysulfone, polystyrene, polyphenylene, ether, amorphous polyamide, acrylic, poly(2-ethyl-2-oxazoline), and the mixtures thereof.

Said first set of particles comprises hexagonal boron nitride particles, and the second set of particles comprises silica particles. Other types of particles can of course be used to ensure the repulsion of the fluids and to limit the wetting of the cavity surface by the latter, the choice thus being made according to the type of fluids in question.

Finally, according to an embodiment considered, said second set of particles is situated closer to the bottom of the cavity than the first set of particles, and said second set comprises particles having water-repellent properties. Thus, in case of prior coating of the structured surface by a first fluid, the latter is prevented from entering into the cavities, thanks to the first set of particles situated closed to the opening of the cavities. Then, when the structured surface is in contact with water as the second fluid, the water is prevented from reaching the bottom of the cavities, thanks to the second set of particles situated lower in the cavity. The cavity bottom thus remains filled with air, and this, even in case of mechanical forces on the structured element, like friction or impacts. In other words, the hydrophobicity of the structured surface is conserved, even in case of prior coating of this surface by another fluid, in theory, likely to be introduced into the cavities.

The invention also aims for a static mixer comprising at least one structured element such as defined above.

Other advantages and characteristics of the invention will appear in the non-limiting, detailed description below.

### BRIEF DESCRIPTION OF THE DRAWINGS

This description will be made in relation to the appended drawings, among which;

FIG. 1 represents a perspective view of a static mixer comprising one or more structured elements according to the invention;

FIG. 2 represents a top view of a part of one of the structured elements shown in the preceding figure;

FIG. 3 is a cross-section view, taken along line III-III of FIG. 2;

FIG. 4 is a cross-section view, taken along line IV-IV of FIG. 3;

FIG. 5 is a cross-section view, taken along line V-V of FIG. 3;

FIG. 6 is a view, similar to that of FIG. 3, according to an alternative embodiment;

FIG. 7 is a view, similar to that of FIG. 2, according to another alternative embodiment;

FIG. 8 is a view, similar to that of FIG. 6, according again to another embodiment;

FIGS. 9a and 9b are alternatives of embodiments to those shown in FIGS. 2 and 7;

FIG. 10 is a perspective view of a part of a structured element according to another preferred embodiment of the invention;

FIGS. 11a and 11b schematise the steps of implementing a method for producing the structured element represented in FIGS. 2 to 5; and

FIGS. 12a and 12b schematise another application of the invention, wherein the fluids circulate successively over the structured element.

### DETAILED DESCRIPTION OF PREFERRED EMBODIMENTS

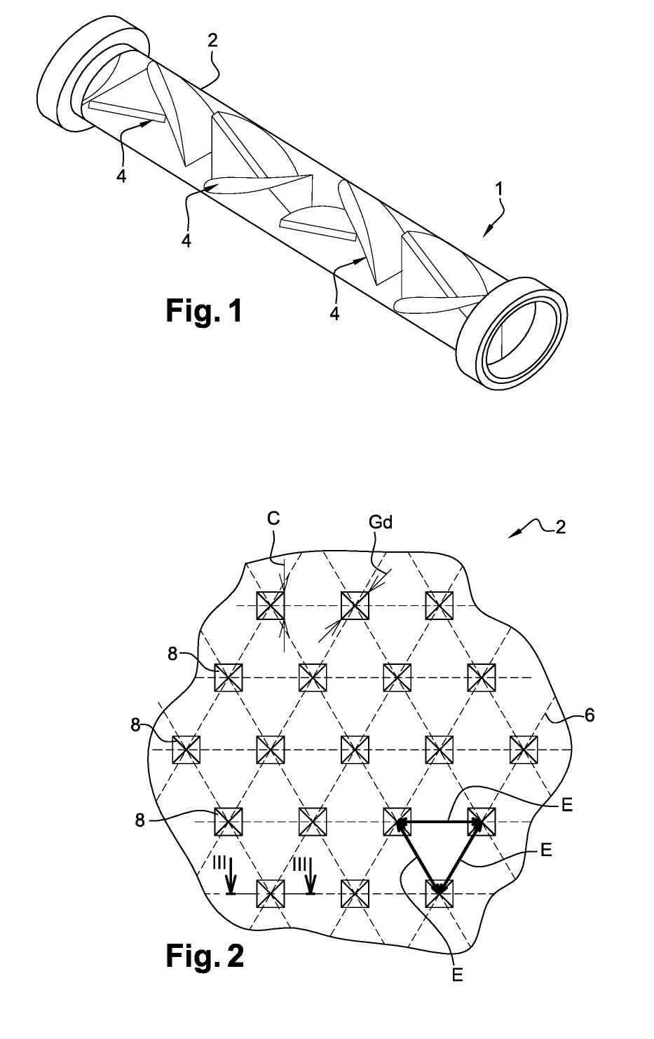

In reference first to FIG. 1, a static mixer 1 is represented, comprising a duct 2 wherein at least two fluids are intended to be mixed. Within this duct 2, the structured elements 4 forming mixing members are arranged. These elements 4 have, for example, a helix shape, suitable for enabling an optimal mixture of the fluids which encounter these elements by circulating inside the duct 2.

As a non-limiting example, this static mixer 1 can be dedicated to the formation of droplets of two fluids considered immiscible, like water and Vaseline oil. Such a technique is defined in the document, “T. Lemenand et al., Formation de gouttelettes dans un mélange turbulent de deux fluides immiscibles, XVème Congrès Francais de Mécanique, Nancy, 2001 (Formation of droplets in a turbulent mixture of two immiscible fluids, 15^{th} French Mechanics Congress, Nancy, 2001)”.

A part of one of the structure elements 4 is shown as a top view in FIG. 2. In this figure, one of the outer surfaces of the element 4 is therefore represented, corresponding to a structured surface for circulating fluids 6. This surface is flat or has one or more curves. It is referred to as structured, as it comprises a multitude of cavities 8, distributed regularly over this surface 6. In FIG. 2, as well as in other figures, the dimensions of the cavities have been voluntarily enlarged, for obvious clarity reasons. However, as will be detailed below, it is to be understood that these cavities 8 are small. For example, the opening thereof has a square or rectangular shape, of which the greatest size “Gd” corresponding to the diagonal is between 600 and 750 μm. The side “C” of these openings is indeed around 500 μm.

The cavities 8 are here arranged along a triangular-shaped mesh, as has been schematised by the dotted line in FIG. 2. Thus, a cavity 8 is located at the level of each one of the tops of the triangles, of preferably equilateral shape. The centre distance “E” between these cavities 8, also corresponding to the step or again, to the length of the sides of the triangles, is around 1 to 3 mm, and more preferably still, close to 2 mm. Other shapes are however possible for the mesh, as FIGS. 9a and 9b show, representing respectively a square or rectangular mesh, as well as a hexagonal mesh.

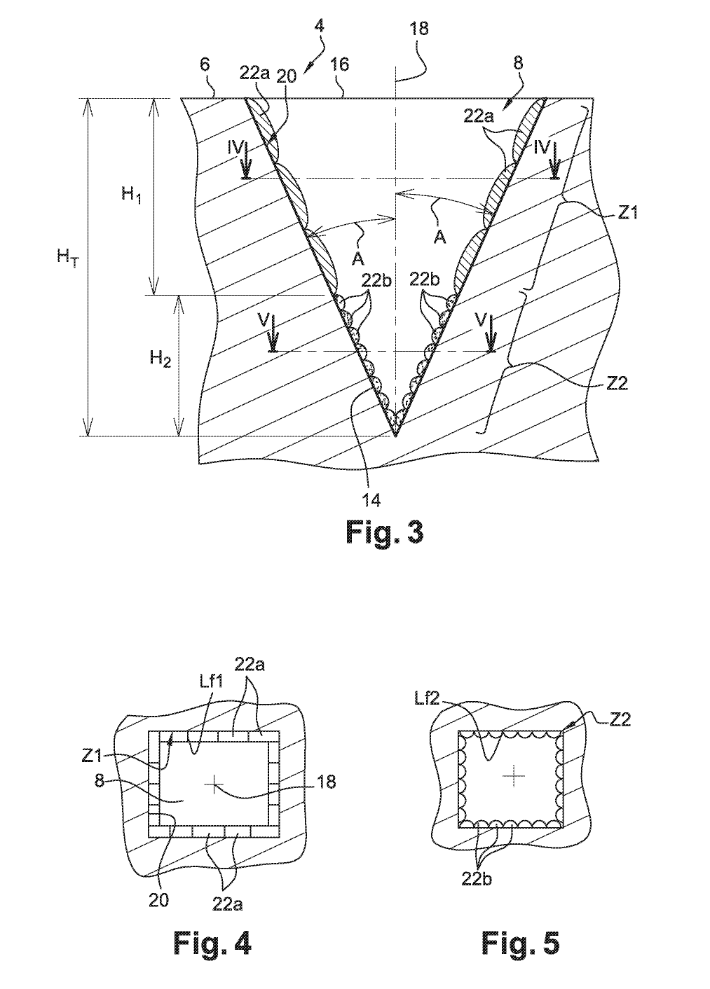

Now in reference to FIGS. 3 to 5, one of the cavities 8 presents on the surface 6 of the structured element 4 is represented. This cavity 8 is flared by going from the bottom 14 thereof to the opening 16 thereof, offset along a direction of depth 18, preferably orthogonal locally to the structured surface 6. More specifically, in this embodiment, the cavity 6 has a general shape of a pyramid with a square base, with this base corresponding to the opening 16. In other words, the cavity surface 20 corresponds to the meeting of four triangular faces, of isosceles or equilateral type. In the cross-section, such as shown in FIG. 3, the tilt angle “A” between each one of these faces and the direction of depth 18 is preferably between 20 and 30°.

Along the direction 18, passing through the top of the pyramid and corresponding to the central axis of the cavity 8, this has a depth, preferably of between 100 and 500 μm. This depth, corresponding to the total height “Ht” of the cavity, is here segmented into two part of respective heights “H1” and “H2”, of identical or similar ranges. However, another distribution can be adopted between the two heights “H1” and “H2”, which succeed the opening 16 towards the bottom 14 of the cavity, without moving away from the scope of the invention. More specifically, the height “H1” corresponds to the height of a first zone Z1 of the cavity surface 20, whereas the height “H2” corresponds to the height of a second zone Z2 of this surface 20, being specified that the two zones are adjacent along the direction of depth 18. The zone Z1, defining, at the high end thereof, the opening 16, thus has a truncated pyramid shape, whereas the zone Z2 which defines the bottom 16 itself has a pyramid shape.

In this preferred embodiment, the first zone Z1 is totally coated with a first set of particles 22a, for example, of flat shapes, and of greater sizes of between 1 and 10 μm. The particles 22a thus extend all along each closed line of the first zone Z1, like the closed line Lf1 of square shape, falling into the cross-section plane in FIG. 4. The type of these particles 22a is determined so as to ensure the repulsion of a first fluid, in order to result in a weak mesh of these particles 22a by the first fluid. This enables to avoid the first fluid entering into the cavity 8, and being deposited in the bottom 14 of it. For information purposes, the material used to produce this first set of particles 22a is hexagonal boron nitride.

Similarly, the second zone Z2 is totally coated with a second set of particles 22b, for example, of hemispheric shapes with diameters of between 0.2 and 0.6 μm. The particles 22b thus extend all along each closed line of the second zone Z2, like the closed line Lf2 of square shape falling into the cross-section plane in FIG. 5. The type of these particles 22b is itself also determined so as to ensure the repulsion of a second fluid, in order to result in a weak mesh of these particles 22b by the second fluid. This enables to avoid the second fluid entering into the bottom of the cavity 8. For information purposes, the material used to produce this second set of particles 22b is silica, for example, a silica aerogel.

Furthermore, the materials are chosen such that the second set of particles 22b ensures a weaker repulsion of the first fluid than that provided by the first set of particles 22a, and vice versa. These particles are coated over the cavity surface, by being preferably semi-concealed in it. The body of the structured element 4, which forms a substrate for the particles 22a, 22b, is preferably of the amorphous and semi-crystalline thermoplastic polymer type, for example: high-density polyethylene (HDPE), polymethylmethacrylate (PMMA), or polycarbonate (PC).

Other morphologies can be provided for the gradient coating of energy present on the cavity surface 20, like for example by reversing the first and second set of particles. However, this morphology of the coating, corresponding to the composition thereof and the shape thereof on the micrometric scale, can be modified further, for example, by varying the ratio of the heights “H1” and “H2”, by providing for a number of zones greater than two which succeed one another along the direction 18, or again, by providing for one or more zones of the cavity surface 20 which are not coated with particles. In the latter case, it is preferably provided, all the same, that at least 50% of the cavity surface 20 is coated with particles enabling to significantly impact the repulsion of a given fluid, implemented in the application in question.

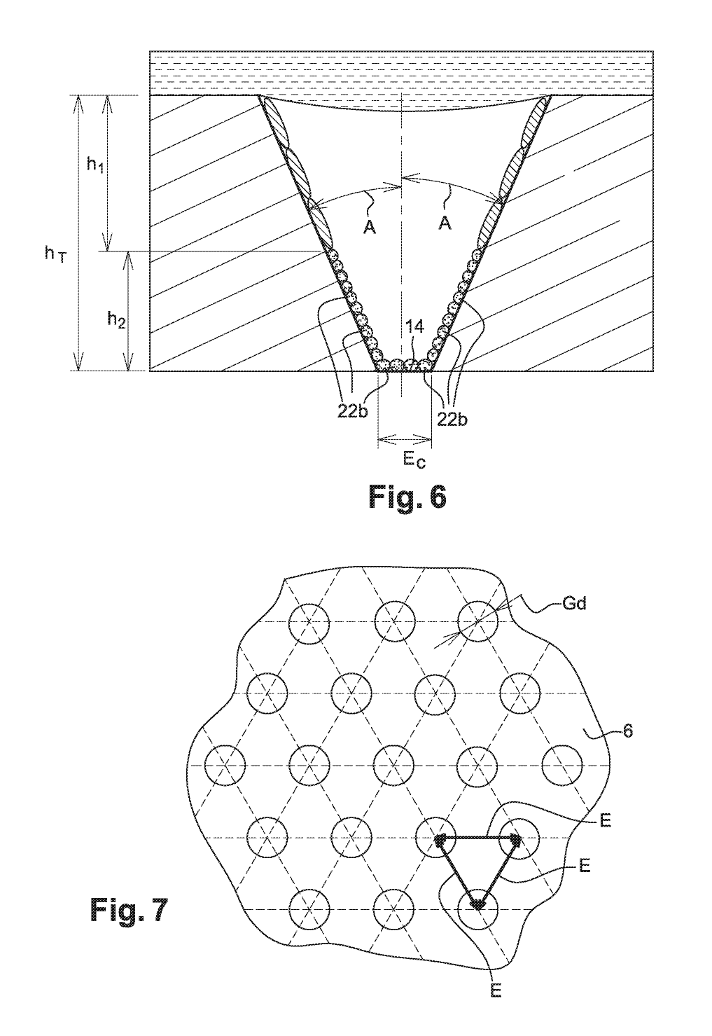

The geometry of the cavities 8 can also differ with respect to that defined above. In particular, as FIG. 6 shows, the pyramid can be truncated at the level of the bottom 14, which is preferably coated by the second set of particles 22b. The gap “Ec” between the triangular faces of the cavity surface is thus around 100 μm at the level of the flat bottom 14.

The pyramid shape of this cavity 8 can incidentally be replaced by a conic shape, as illustrated in FIG. 7. The dimensions of these cavities are identical or similar to those defined for the pyramid cavities. Here too, the cone can be truncated at the level of the bottom 14.

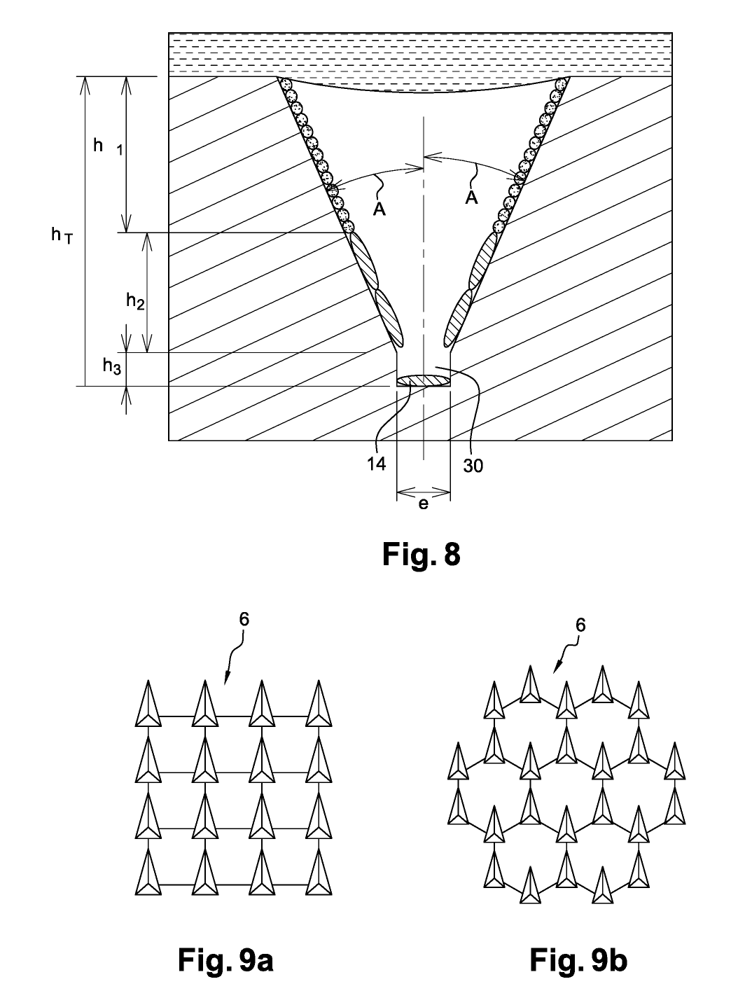

Also, the cavity 8 can have a lower cylindrical-shaped part, namely the constant section of which the geometry is that of the section of the remainder of the cavity. As is shown in FIG. 8, this lower cylindrical part forms a reservoir 30, of which the bottom thus constitutes the bottom 14 of the cavity, preferably coated with particles. The side wall of the reservoir itself is not necessarily coated with particles.

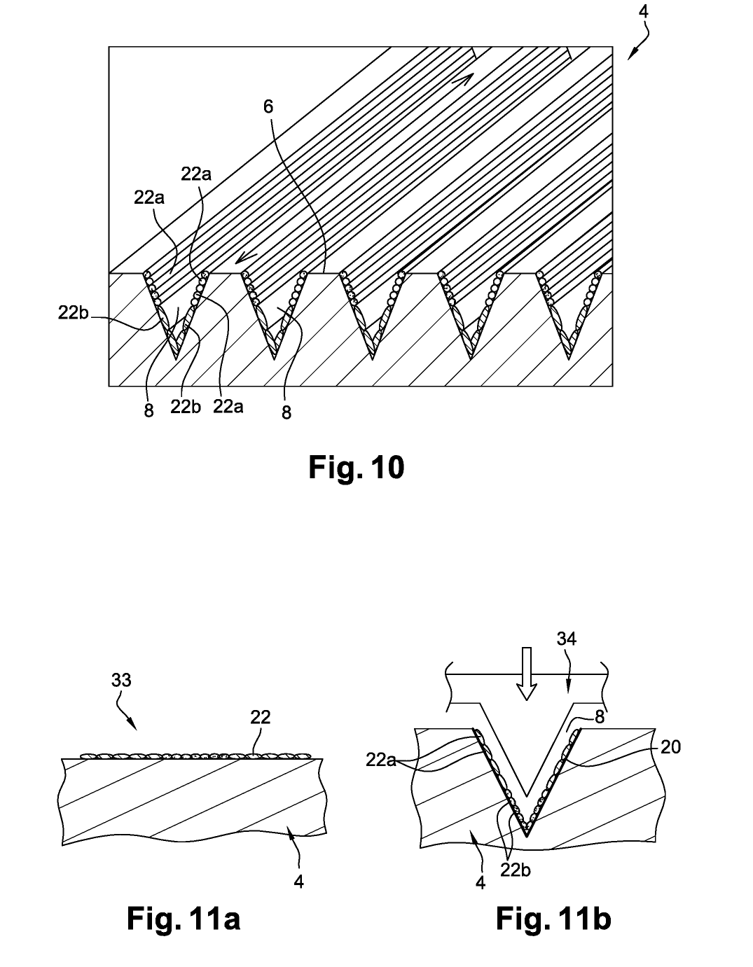

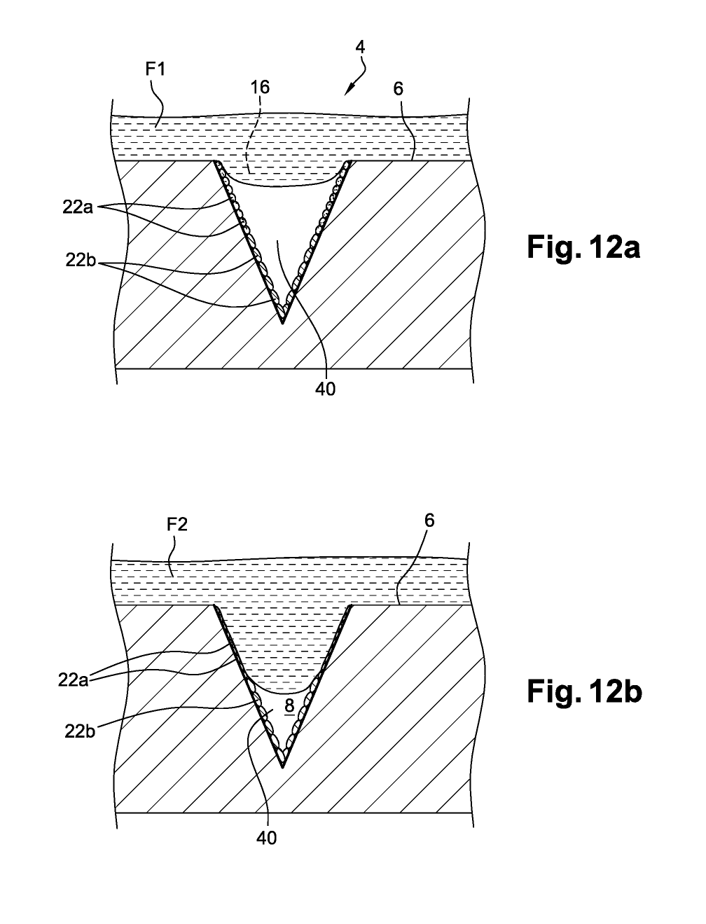

Finally, in another embodiment, considered and shown in FIG. 10, the cavities 8 are no longer specific and arranged along a given mesh. They form parallel grooves, preferably with a V-shaped cross-section. The coating thereof by the first and second sets of particles 22a, 22b is similar to that defined for specific cavities. On each side of the groove 8, a strip of first particles 22a is located, arranged above a strip of second particles 22b.

Whichever the configuration considered, numerous techniques can be used to produce the structured element 4. The one preferred, shown in FIGS. 11a and 11b, consists of depositing on the not-yet structured flat element 4, a film formed from the particles 22a, 22b suitably ordered. This film 33 is, for example, obtained beforehand on a liquid substrate, using the known Langmuir-Blodgett technique, or by implementing a similar technique.

Then, a specific tool 34 is used to produce a hot embossed stamping (also known under the name, “hot embossing”), as illustrated in FIG. 11b. This stamping simultaneously enables to create cavities 8, and also to inlay particles from the film 33 in the cavity surface 20. The two sets of particles 22a, 22b are thus automatically created on the cavity surface 20 and positioned correctly on it, given that the ordering of the particles is not modified with respect to the ordering done within the film 33.

In the case cited from the application of the invention to a static mixer, the two fluids to be mixed are thus prevented from being introduced into the bottom of the cavities of the mixing element, thanks to the sets of particles 22a, 22b which contribute to the repulsion thereof. The flow of these fluids can thus be produced satisfactorily, through conserving air in the cavities 8, implying reduced friction during the passage of these fluids over these cavities. Furthermore, the variation in the speed distribution created by the rotation of slippage zones at the level of the air-filled cavities 8, and of less-slipping zones at the level of the smooth parts of the structured surface 8, constitutes a fluid recirculation source generating turbulence conducive to a better mixture of the fluids within the static mixer.

What is claimed is:

1. Structured element (4) intended to be in contact with at least one first fluid (F1) and one second fluid (F2), the structured element comprising a surface for circulating fluids (6) structured by the presence of air cavities (8) with a depth of between 100 and 1000 μm and distributed regularly over the structured surface (6), each cavity (8) being delimited by a cavity surface (20),
wherein the cavity surface comprises at least one first zone (Z1) and one second zone (Z2) succeeding one another along a direction of depth (18) of the cavity, the first zone being coated with a first set of particles (22a) having properties for repelling the first fluid, and the second zone being coated with a second set of particles (22b), different from the first set and having properties for repelling the second fluid, the second set of particles ensuring a weaker repulsion of the first fluid than the first set of particles, whereas this latter ensures a weaker repulsion of the second fluid than the second set of particles.

2. Structured element according to claim 1, wherein the depth of the air cavities (8) is between 100 and 500 μm.

3. Structured element according to claim 1, wherein said first and second sets of particles (22a, 22b) comprise particles of which the greatest size is between 0.2 and 10 μm.

4. Structured element according to claim 1, wherein said first and second sets of particles (22a, 22b) comprise flat-shaped and/or hemispheric particles.

5. Structured element according to claim 1, wherein the cavities (8) are distributed regularly over the structured surface (6) along a triangular, square, rectangular or hexagonal-shaped mesh.

6. Structured element according to claim 5, wherein each cavity has a greater size (Gd) of between 600 and 750 μm.

7. Structured element according to claim 5, wherein each cavity (8) is flared by moving closer to the opening (16) thereof, and preferably takes the general shape of a cone or of a pyramid, possibly truncated.

8. Structured element according to claim 7, wherein each cavity (8) has a lower, cylindrically-shaped part forming a reservoir (30), of which the bottom (14) is preferably coated with particles.

9. Structured element according to claim 5, wherein each first/second set of particles (22a, 22b) extends all along a closed line (Lf1, Lf2) of the first/second zone (Z1, Z2) of the cavity surface (20).

10. Structured element according to claim 1, wherein the cavities (8) are distributed regularly over the structured surface (6) by forming parallel grooves.

11. Structured element according to claim 1, wherein said cavity surface (20) has a tilt, with respect to a direction of depth (18) of the cavity (8), of between 15 and 35°, and more preferably between 20 and 30°.

12. Structured element according to claim 1, wherein it is produced using one of the following materials:
high-density polyethylene;
polymethylmethacrylate;
polycarbonate.

13. Structured element according to claim 1, wherein said first set of particles (22a) of hexagonal boron nitride, and in that the second set of particles comprises silica particles (22b).

14. Structured element according to claim 1, wherein said second set of particles (22b) is situated closer to the bottom (14) of the cavity than the first set of particles (22a), and in that said second set comprises particles having properties for repelling water.

15. Static mixer (1) comprising at least one structured element (1) according to claim 1.
